(19) United States
(12) Patent Application Publication
(10) Pub. No.: US 2006/0253296 A1
(43) Pub. Date: Nov. 9, 2006

(54) Medical advisory system

(75) Inventors: Christian Liisberg, Hundested (DK); Jette Randlov, Vaerlose (DK); Jon Ulrich Hansen, Herlev (DK); Jens Ulrik Poulsen, Virum (DK)

Correspondence Address: NOVO NORDISK, INC.;PATENT DEPARTMENT, 100 COLLEGE ROAD WEST, PRINCETON, NJ, 08540, US

(73) Assignee: Novo Nordisk A/S, Bagsvaerd (DK)

(21) Appl. No.: 11/410,450

(22) Filed: Apr. 25, 2006

Related U.S. Application Data
(63) Continuation of application No. PCT/DK04/00742, filed on Oct. 28, 2004.
(60) Provisional application No. 60/518,900, filed on Nov. 10, 2003.

(30) Foreign Application Priority Data
Oct. 29, 2003 (DK) PA 2003 01599

(51) Int. Cl. G06Q 99/00

(52) U.S. Cl. 705/1

(57) ABSTRACT

Disclosed is a medical advisory system for providing recommendations to a user for actions to be taken. The system comprises input means for receiving a number of input parameters, processing means configured to determine from at least the input parameters a recommended action to be taken, and output means for presenting information about the determined recommended action to a user. The processing means is configured to implement a plurality of mathematical advisory models each adapted to generate a respective model output from the received input parameters. The processing means is configured to determine the recommended action from the model output of one or more of the plurality of mathematical advisory models.

### CROSS REFERENCE TO RELATED APPLICATIONS

This application is a continuation of International Application serial no. PCT/DK2004/000742 filed Oct. 28, 2004 and claims priority from Danish Application serial no. PA 2003 01599 filed Oct. 29, 2003 and to U.S. Provisional Application Ser. No. 60/518,900 filed Nov. 10, 2003.

The invention relates to a medical advisory system for providing recommendations to a user for actions to be taken.

A medical advisory system is a system which provides recommendations to a user based on a number of input parameters, e.g. parameters describing the physiological or medical state of the patient, parameters describing previous actions of the patient, or the like. In particular, the present invention relates to a diabetes advisory system which outputs recommendations for choices of actions to be taken by a diabetes patient, e.g. a recommended medication, physical exercise, nutrition, etc. Typical input parameters to such a system are the previously applied and/or expected medication, meals, exercise, etc.

It is a general requirement for such systems that they are reliable, i.e. provide a correct recommendation based on the given input data.

U.S. Pat. No. 5,822,715 discloses a diabetes management system that comprises a patient-operated apparatus programmed to predict the patient's future blood glucose values based on a measured present blood glucose value. Based on the predicted future value, the apparatus determines a corrective action to be taken by the patient, if the predicted blood glucose value lies outside a target range.

It is an object of the present invention to provide a medical advisory system providing recommendations with a high reliability.

The above and other problems are solved by a medical advisory system for providing recommendations to a user for actions to be taken, the system comprising:
input means for receiving a number of input parameters;
processing means configured to determine from at least the input parameters a recommended action to be taken; and
output means for presenting information about the determined recommended action to a user;
   wherein the processing means is configured to implement a plurality of mathematical advisory models each adapted to generate a respective model output from the received input parameters; and wherein the processing means is configured to determine the recommended action from the model output of one or more of the plurality of mathematical advisory models.

Hence, by providing a plurality of mathematical models, each adapted to generate a respective model output from the received input parameters, the reliability of the recommendations is improved, since unsatisfactory or even incorrect recommendations generated by one model may be detected and/or compensated by another one of the plurality of models. Hence, an overall improvement of the reliability is achieved, even in situations, e.g. for ranges of the input parameters, where the performance of one of the mathematical models is unsatisfactory.

According to a preferred embodiment of the invention, the plurality of mathematical advisory models comprises at least a first advisory model and a fall-back model; the processing means is configured to select one of the first advisory model and the fall-back model based upon at least one of an input to and a model output of at least the first advisory model; and the processing means is further configured to determine the recommended action from the selected model. Hence, based on the input and/or output to/from the first advisory model, the processing means determines whether to accept the recommendation of the first advisory model or whether to use a fall-back model. It is an advantage that the performance of the first advisory model is supervised, resulting in an improved reliability and verifiability of the system.

According to a further preferred embodiment of the invention, the processing means is configured to determine a reliability measure for a model output of at least the first advisory model; and the processing means is further configured to determine the recommended action from at least the first advisory model, if the determined reliability measure is above a predetermined threshold, and to determine the recommended action from said fall-back model, if the determined reliability measure is below the predetermined threshold.

It is an advantage that the risk of false recommendations is reduced, thereby further improving the reliability of the system. Furthermore, it is an advantage that the system performance may be easily validated, since the quality of the recommendations does not decrease below the quality of the fall-back system. In particular, this is an advantage in connection with adaptive models, e.g. in a system that is continuously adapted in an on-line fashion. According to a preferred embodiment of the invention, it is ensured that the performance of the adaptive system does not drift into an unacceptable regime. However, it is understood that the system may also be applied to non-adaptive models.

In a further preferred embodiment, the fall-back model comprises a rule-based fall-back model, thereby allowing a systematic validation of the fall-back model. Alternatively, another verified fall-back model having a verified performance may be used, e.g. a model where the output for each possible set of input values has been verified. When the fall-back model is non-adaptive, the performance of the fall-back model is ensured to remain constant over time.

In one embodiment, the system comprises a layered architecture including an advanced prediction module and a simple, preferably rule-based, fall-back module. The system further comprises a supervision module which monitors the performance of the advanced prediction module and determines a reliability measure for the performance. If, for a given set of input data, the reliability measure is below a certain threshold, the input data are fed into the fall-back system instead.

The term rule-based model is intended to comprise any model comprising a set of predetermined rules assigning respective recommended actions to each of a set of predetermined ranges of parameters. Hence, in a preferred embodiment, the rule-based fall-back system comprises an exhaustive list of ranges of input parameters and respective recommended fall-back actions for each of the ranges of input parameters, thereby allowing a complete and systematic validation of the system. In some embodiments, such rule-based models are implemented in the form of one or more tables, thereby further facilitating a systematic model validation.

When attempting to achieve approval for the marketing of such an advisory system it often needs to be proven that it performs reliably. According to an embodiment of the invention, a systematic mechanism for validating the reliability of the system in all situations is facilitated.

The term reliability measure is intended to comprise any quantity that is indicative of a probability and/or confidence and/or the like that the generated recommended action is correct. In some embodiments, the reliability measure is a quantity derived from at least one of the input to and/or the output from one or more of the plurality of models. For example, some models generate continuous values to a number of candidate actions and select an action based on the generated values, e.g. an action having a highest value. In such models, the relative magnitude of the output values of the selected action compared to the other candidate actions is a measure of confidence in the selected action. Further examples of such reliability measures comprise a result of a sensitivity analysis of a model output, a result of a comparison of outputs from several models, e.g. a measure of similarity, a voting scheme, or the like. When the processing means is adapted to determine the reliability measure from a comparison of at least a first model output of the first advisory model with at least a second model output of a second one of the plurality of mathematical advisory models, an accurate reliability measure is achieved. Other examples of reliability measures may be based at least in part on the model inputs, e.g. by comparing one or more of the input parameters with a range of inputs within which the model is trusted to generate reliable results, and/or by determining any missing inputs, and/or the like. Yet further examples of reliability measures utilise historical information, e.g. previous model inputs and/or outputs and/or received user feedback for previous recommendations. For example, if a user has indicated that a recommendation given for a certain set of input parameters was not useful, the reliability of the advisory model may be multiplied with a certain penalty factor during a subsequent prediction for the same or similar input parameters. Yet further examples of reliability measures include a comparison of the model output with a verified model or set of rules, e.g. established/recognised clinical guidelines for a physiological situation.

For the purpose of the present description, the term mathematical advisory model is intended to comprise any computer-implemented mathematical process which receives a number of input parameters and determines a recommended action based on the received input parameters and, optionally, a number of model parameters. Examples of such models include statistical models, neural network models, reinforcement models, physiological models, or the like.

According to another preferred embodiment, at least one of the plurality of mathematical advisory models comprises a prediction module for predicting a future value of a physiological parameter; and a control unit for determining a recommended action from at least the predicted future value of the physiological parameter. Consequently, in this embodiment, one or more of the plurality of models determine a predicted future physiological parameter, e.g. blood glucose, and determine a recommended action based on the prediction, e.g. by comparing the predicted value with a target value, a target range, or the like. It is an advantage that the model provides a prediction of the future value of the physiological parameter, thereby allowing the system to provide the predicted value as additional information to the user. Hence, the user may make a decision about the action(s) to be taken based on the recommendation generated by the system and based on the predicted physiological value. Providing the predicted value of the future physiological parameter as additional information to the user further provides an implicit explanation for the recommended action to the user, thereby increasing the amount of trust a user may have in the given recommendation and, thus, increasing the likelihood that the user actually would follow the recommendation.

Other models determine the recommended actions directly from the input parameter, i.e. by an algorithm that relates the input parameters directly to recommended actions, thereby avoiding the need for any assumptions of the underlying physiological processes, etc.

The system generates a recommended action from the model outputs of a plurality of mathematical models. In some embodiments, the models are operated as an ensemble or committee of models. Hence, according to this embodiment, the processing means is adapted to determine respective model outputs of each of at least a subset of the advisory models, the subset comprising a plurality of mutually different models, and to determine the recommended action from a combination of the determined model outputs. For example, in one embodiment, each model may generate a recommendation for an action, and the system selects the action as overall recommended action which has received the majority of votes. It is an advantage that the output of an ensemble or committee of models improves the reliability of the overall output. It is a further advantage that a measure of reliability of the overall model output can be established from the degree of dissimilarity of the individual model outputs.

In other embodiments, the plurality of models is operated as a hierarchy of models. As described above, the system may select the output generated by one model or a group of models as recommended action based on a reliability measure of the corresponding model output(s).

In some embodiments the mathematical model comprises model parameters that are adaptable in order to improve the quality of the mathematical model. For example, the model parameters may be adapted by a suitable adaptation process e.g. based on a comparison of the model output and a reference value. For example, if the model comprises a prediction of a future value of a physiological parameter such as the blood glucose level, a reference value may be a measured value of the physiological parameter at a predetermined future time. In other embodiments, the reference value may be a recommended action determined by a human expert, e.g. a physician.

Examples of such adaptive models are models that are adapted based on a Least Squares Error method, a Maximum Likelihood method, or any other suitable optimisation method. Other examples of adaptive models include neural network models which may be updated by so-called learning algorithms such as the back-propagation algorithm or the like. Yet further examples include so-called case-based reasoning, i.e. an adaptive model where new cases or examples are added to a case database, thereby increasing the probability of finding a close match to the situation being analysed.

Hence, in some embodiments, at least one of the plurality of mathematical advisory models is an adaptive mathematical mode, thereby allowing to adapt the advisory system to a particular patient or even to continuously improve the recommendations by a model adaptation during operation.

In yet another preferred embodiment at least one of the plurality of mathematical advisory models comprises a plurality of look-up tables, a corresponding plurality of address decoder modules, and a combiner module; wherein each look-up table includes a corresponding plurality of columns, each column comprising a plurality of table entries; wherein each of the address decoders is adapted to determine one of the plurality of columns of a corresponding one of the look-up tables; and wherein the combiner module is adapted to determine the model output of the mathematical advisory model from the table entries of the determined columns, thereby providing a system, that may efficiently be adapted to a given patient, e.g. by a continuing adaptation during operation.

As mentioned above, the model output of each of the plurality of models may be an action recommended by that model. Alternatively, the model output may be a rating of a number of candidate actions, assigning respective rating values to each of the candidate actions. In yet another embodiment, each model may generate a predicted value of a relevant physiological parameter, and the processing unit then determines a recommended action from the predicted values generated by the different models. In some embodiments, one or more of the models may generate a combination of the above outputs.

Additionally, one or more of the models may generate further outputs, e.g. a confidence or reliability measure of the generated output.

The recommendations for actions determined by the system may be any action to be taken by the patient that may influence the medical/physiological state of the patient to be controlled. It is understood that examples of such actions include a “do nothing” recommended action, e.g. in a situation where no change in behaviour is recommended. It is further understood that, in some embodiments, one or more of the recommended actions may involve the consultation of a physician or other expert. In the example of controlling the blood glucose level of a patient, examples of recommended actions may include actions regarding insulin intake, the intake of food, the level of physical exercise, etc.

It is further understood that, in some embodiments, more than one action may be presented to the user at least in some situations. For example, the system may present a number of alternative actions, each of which providing the same or a similar desired effect. In this example, the user may choose an action from the presented number of actions. In another example, a recommended action may be a composite action, i.e. an action comprising a plurality of individual actions, e.g. “eat a snack and rest for 30 min.”, where the user is recommended to perform all the presented actions.

In yet another embodiment, the system further presents the determined reliability measure for the presented recommended action(s). For example, in an embodiment where several alternative recommendations are presented, the user is provided with a further guidance in selecting one of the recommendations based on the reliability measures for the different presented actions. It is a further advantage that the presentation of the reliability measure increases the confidence which the user has in the system, thereby increasing the likelihood that the user actual follows the recommendations.

The system receives a number of input parameters, preferably parameters that provide information about the state of the system which is to be controlled, i.e. parameters that carry information relevant for the selection of the recommended action. For example, when the advisory system is used by a patient in order to control a physiological parameter, such as blood glucose, measured values of the parameter may be provided as input parameters. Other examples of input parameters include secondary parameters influencing the physiological parameter to be controlled, e.g. previous actions taken by the patient such as previous physical exercise, food intake, insulin dosages, etc. Yet another group of examples include measured parameters or sensor data, such as a patient's heart rate, body or skin temperature, skin resistance, etc.

The input parameters may be input by the user and/or received from sensors, measuring devices and/or in any other suitable way. Accordingly, the input means may comprise any circuitry or device suitable for receiving data. Examples of such input means comprise user-input devices, such as a keyboard, keypad, push buttons, pointing devices, touch screens, or the like. Further examples include interfaces for receiving data from a sensor or measuring device, e.g. from external devices or sensors, or from sensors integrated into the advisory system. Yet further examples include data communications interfaces suitable for receiving data via a communications network, e.g. a wireless network or a wired network.

The processing means may include any circuit and/or device suitably adapted to perform the above functions. In particular, the processing means may comprise a general- or special-purpose programmable microprocessor, a Digital Signal Processor (DSP), an Application Specific Integrated Circuit (ASIC), a Programmable Logic Array (PLA), a Field Programmable Gate Array (FPGA), a special purpose electronic circuit, etc., or a combination thereof.

The output means may include any device or circuitry suitable for presenting information about a recommended action to a user. For example, the advisory may provide a display for displaying a recommended action. Alternatively or additionally, the output means may include an audio output for providing an audible indication of the recommended action or for alerting the patient, e.g. of the presence of an urgent recommendation. It is understood that, alternatively or additionally, any other suitable means for indicating a result to the user and/or for alerting the user may be used, e.g. a vibrator or another means for providing a tactile output.

In some embodiments, the output means, the input means, and the processing means are provided as part of a single device, e.g. a portable or a hand-held electronic device, thereby providing a convenient tool for providing recommended actions that can be operated independently of any remote devices. Examples of such devices include suitably programmed computers, e.g. a portable or hand-held computer, a Personal Digital Assistant (PDA), a special-purpose medical device, or the like. Further examples include a suitably programmed mobile telephone or other communications device.

In some embodiments, the advisory system comprises a user terminal and a remote data processing system. The user terminal, e.g. a hand-held electronic device such as a mobile telephone or other communications device, a PDA, or the like, comprises the output means and the input means, and suitable communications means for transmitting the input parameters to the remote data processing system and for receiving information about the recommended action. The remote data processing system, e.g. a computer of a hospital or the like, comprises communications means configured to receive/transmit the above data from/to the user terminal, and processing means configured to determine the recommended action from the input parameters.

Further preferred embodiments are disclosed in the dependant claims.

The present invention can be implemented in different ways including the above-mentioned system, a method, and further product means, each yielding one or more of the benefits and advantages described in connection with the first-mentioned system, and each having one or more preferred embodiments corresponding to the preferred embodiments described in connection with the first-mentioned system and as disclosed in the dependant claims.

In particular, the invention further relates to a computer-implemented method of providing recommendations to a user for actions to be taken, the method comprising:
receiving a number of input parameters;
determining from at least the input parameters a recommended action to be taken; and
presenting information about the determined recommended action to a user;
   wherein determining the recommended action further comprises
providing a plurality of mathematical advisory models;
determining one or more respective model outputs of one or more of the plurality of mathematical advisory models and from the received input parameters; and
determining the recommended action from the determined one or more model outputs.

It is noted that the features of the method described above and in the following may be implemented in software and carried out in a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

The above and other aspects of the invention will be apparent and elucidated from the embodiments described in the following with reference to the drawing in which:

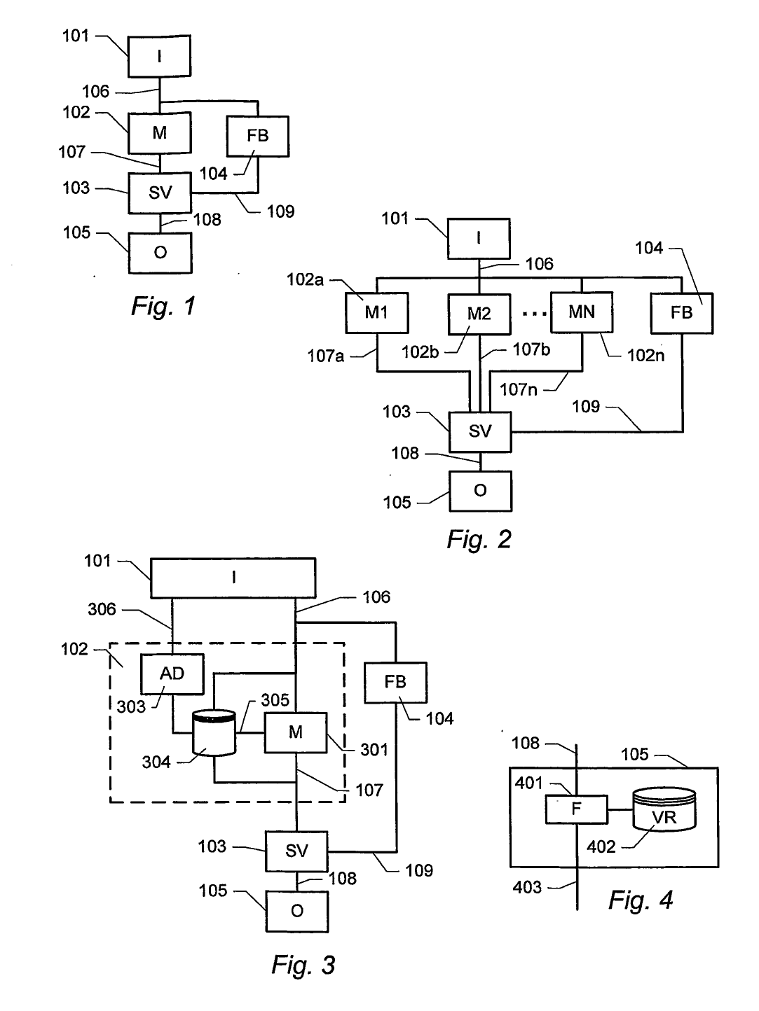

FIG. 1 shows a block diagram of functional components of an embodiment of a medical advisory system;

FIG. 2 shows a block diagram of functional components of another embodiment of a medical advisory system;

FIG. 3 shows a block diagram of functional components of yet another embodiment of a medical advisory system;

FIG. 4 shows a block diagram of an embodiment of an output module of a medical advisory system;

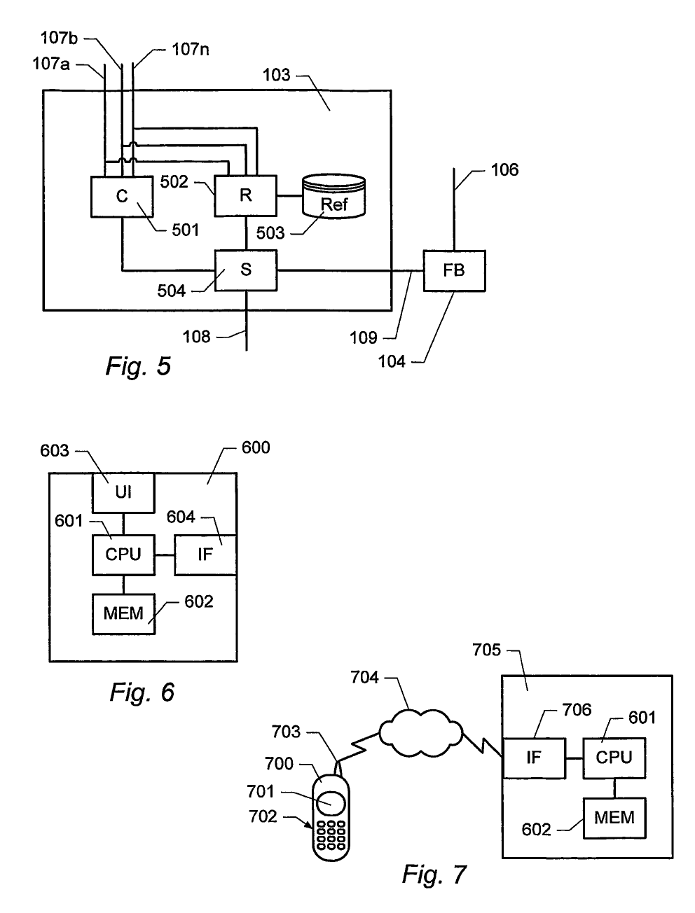

FIG. 5 shows a block diagram of an embodiment of a supervisor module of a medical advisory system;

FIG. 6 shows a block diagram of a medical advisory system;

FIG. 7 shows a block diagram of a medical advisory system comprising a hand-held electronic device and a remote data processing system;

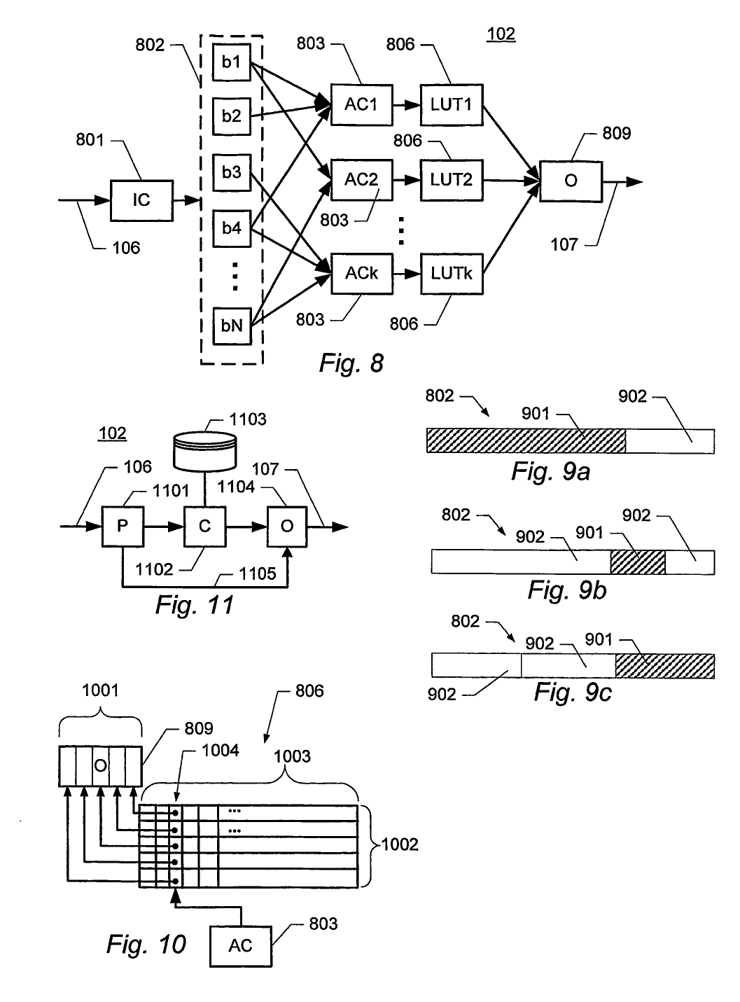

FIG. 8 illustrates an advisory model based on look-up tables;

FIGS. 9a-c illustrate examples of an input layer coding in the advisory system of FIG. 8;

FIG. 10 illustrates one of the look-up tables of the model of FIG. 8; and

FIG. 11 illustrates an advisory model where the recommended action is determined on the basis of a prediction of a blood glucose value.

In the drawings like reference signs correspond to like or corresponding elements, steps, etc.

FIG. 1 shows a block diagram of the functional components of an embodiment of a medical advisory system. The advisory system comprises an input module 101, an advisory module 102, a supervisor module 103, a fall-back system 104, and an output module 105. The input module 101 receives the input parameters such as input parameters provided by a user and/or input parameters provided by a measuring device, a sensor, and/or any other external system. In some embodiments, the input module may perform one or more pre-processing steps on one or more of the input parameters. Examples of such pre-processing steps include, analogue-to-digital conversion, noise reduction, e.g. by averaging over a predetermined time-window, calculation of correlations between two or more input parameters, etc.

It is understood that the number and type of input parameters as well as the type of pre-processing depends on a specific implementation. For example, in the context of providing recommendations to a diabetes patient regarding the control of the blood glucose level, possible input parameters are parameters regarding medication, diet, physical exercise, physiological parameters such as a measured blood glucose level, hart rate, skin temperature, skin resistance, or the like.

The input module 101 feeds the received and, optionally, pre-processed input parameters 106 to the advisory module 102. The advisory module 102 determines a recommended action from the input parameters 106 and according to a predetermined advisory model, i.e. an algorithm for calculating a recommended action from the received input data and, optionally, auxiliary data, e.g. time, historic data such as previously received input parameters, or information about the patient, e.g. the patients age, sex, weight, etc. Examples of such algorithms include adaptive and non-adaptive mathematical models, such as neural networks, look-up tables, pattern recognition algorithms, multivariate statistical analysis, physiological models, or the like. Embodiments of adaptive mathematical models will be described in greater detail below. The advisory module 102 further generates reliability information about the determined recommended action, e.g. a confidence level for a selection of a given action from a set of candidate actions. Examples of reliability measures will be described in greater detail below. The advisory module 102 generates a model output 107 including information about the determined recommended action and the reliability information.

The advisory module 102 feeds the model output 107 including the recommended action and the reliability measure to the supervisor module 103. The supervisor module determines from the reliability measure whether the determined recommended action is sufficiently reliable to be presented to the user. For example, when the reliability measure includes a confidence level, the supervisor module may compare the confidence level with a predetermined threshold. If the confidence level is larger than the threshold, the supervisor module feeds the recommended action determined by the advisory module to the output module 105, as indicated by connection 108. For example, the threshold may be set by a physician during an initial customisation process.

The advisory system further comprises a rule-based fall-back system 104. The fall-back system 104 receives the input parameters 106 from the input module and generates a recommended action 109. The rule-based fall-back system determines the action 109 from a set of predetermined, simple rules, e.g. a set of well-established rules that are known to provide safe recommendations for all possible values of input parameters. For example, the set of fall-back rules may be determined by a physician or other expert and stored in a table indexed by the input parameters. The fall-back recommendation 109 determined by the fall-back system 104 is fed into the supervisor module 103.

If the supervisor module 103 has determined that the recommended action determined by the advisory module 102 is not sufficiently reliable, the supervisor module feeds the fall-back recommendation 109 as final output 108 to the output module. Hence, even if the mathematical algorithm implemented by advisory module 102 does not provide a reliable recommendation, the advisory system is still able to provide a recommendation to the user, thereby avoiding frequent situations where the user does not receive a recommendation. This is an advantage, since situations where the advisory system does not provide a recommendation are dissatisfactory for the user, and they may even disturb the user or require further actions, such a an additional measurement of a blood glucose level, an additional consultation of a physician, or the like. Furthermore, the advisory system provides recommendations with a reliability that is known to be larger than a minimum reliability. In particular, the minimum reliability is determined by the reliability of the fall-back system and by the minimum reliability at which the supervisor module rejects the recommendation of the advisory model.

The output module 105 receives the final recommendation 108 and provides it to the user, e.g. via a user interface such as a display or the like.

FIG. 2 shows a block diagram of functional components of another embodiment of a medical advisory system. The medical advisory system corresponds to the system described in connection with FIG. 1. However, the system of FIG. 2 comprises a plurality of advisory modules, designated 102a, 102b, . . . , 102n, instead of just a single module. For example, the advisory system may comprise 2, 3, 4, 5, or even more advisory modules. Each of the advisory modules receives the input parameters 106 and each of the advisory modules generates a corresponding model output, designated 107a, 107b, . . . , 107n. The model outputs are all fed into the supervisor module 103 which determines the reliability of the model outputs and generates a final recommendation from the model outputs or, if the supervisor module determines the model outputs not to be sufficiently reliable, from the fall-back system 104 as described above. An embodiment of a supervisor module will be described in greater detail below. Preferably, the advisory modules implement different algorithms or algorithms parameterised by different choices of parameters, thereby allowing the supervisor module to determine the reliability of the model outputs from a measure of similarity of the outputs from the different models.

It is understood that, in some embodiments, some of the advisory modules 102a, 102b, . . . , 102n may require different input parameters then others. Hence, in an embodiment where all input parameters are fed to all advisory modules as illustrated in FIG. 2, the individual advisory modules may disregard the parameters that are not required by the respective algorithm. In other embodiments, the input module may feed different sets of input parameters to different advisory modules.

FIG. 3 shows a block diagram of functional components of yet another embodiment of a medical advisory system. The medical advisory system corresponds to the system described in connection with FIG. 1. However, the system of FIG. 3 comprises an advisory module 102 implementing an adaptive mathematical model. The advisory module 102 receives a set of input parameters 106 from the input module 101 and generates a model output 107 including information about a recommended action determined by the advisory module. The advisory module 102 implements an adaptive mathematical model and comprises a model module 301, a data storage 304 for a set of model parameters, and an adaptor module 303. The model module 301 receives the input parameters 106, retrieves the model parameters from the data storage 304 via connection 305, and generates a model output 107 from the input parameters and according to the model parameters, i.e. the model module implements a mathematical model according to y=M(x; p) where x represents the input parameters, p the model parameters, y the model output and M the algorithm implemented by the model. The model module 301 further stores the model output in the data storage 304 for use in a subsequent model adaptation. Furthermore, in some embodiments, the received input parameters 106 are also stored in the data storage 304, for example together with a timestamp.

According to this embodiment, the input module 101 further receives one or more reference values 306 and feeds them to the adaptor module 303. For example, the reference values may comprise recommended advices determined by a physician or other expert for a given medical state of the patient. In other embodiments, where the advisory model comprises a prediction of a physiological parameter, the reference value may comprise an actual measurement of that physiological parameter at a time for which the parameter has been predicted by the model. The reference value(s) may be provided by the user via a user interface of the advisory system. For example, the user may enter a measured value of a physiological parameter and the time of measurement, or the user may indicate the recommended action received from a physician and a time for which that recommendation applies. In some embodiments, the advisory system may even request the user to enter a reference value, e.g. in a situation where a model output was determined to be unreliable, and the system has output a fall-back recommendation.

When the adaptor module 303 receives a reference value 306, the adaptor module retrieves the corresponding model output y, e.g. based on the time to which the reference value applies as indicated by the user. The adaptor module 303 further retrieves the current model parameters p and, optionally, the input x received at the time to which the reference values apply. Based on the received reference values and the retrieved data, the adaptor module determines a set of updated model parameters p′ according to a suitable adaptation algorithm fₐ, e.g. according to p′=fₐ(p, y, y_{ref}, x), where y_{ref} is the reference value corresponding to the model output y. Examples of suitable adaptation algorithms are known in the art and include e.g. real-time back-propagation algorithms, reinforcement learning, and other optimization procedures.

It is an advantage of this embodiment, that the advisory system may be continuously adapted to the particular user, thereby improving the quality of the recommendations during operation. However, at the same time it is ensured by the supervisor module 103 and the fall-back system 104, that the advisory module does not produce unreliable results, e.g. do to erroneous reference values.

It is understood that, in the embodiment of FIG. 2 described above, one or more of the plurality of advisory modules may implement an adaptive model as described in connection with the advisory module of FIG. 3.

FIG. 4 shows a block diagram of an embodiment of an output module of a medical advisory system. The output module receives the recommended action 108 generated by the supervisor module and presents it to the user as described above. According to this embodiment, the output module 105 comprises a final output filter 401 that implements a final level of output validation. The output filter 401 compares the recommended action 108 with a set of validation rules stored in a data storage 402. If the output filter determines that the recommended action 108 is in accordance with the validation rules, the output filter 401 presents the recommendation to the user via a suitable user interface. Otherwise, if the output filter determines that the recommended action 108 is not in accordance with the validation rules, the output filter 401 presents a corresponding message to the user, e.g. inviting the user to contact a physician, to measure a relevant physiological parameter, or the like. Hence, the final output 403 presented to the user comprises a valid recommended action or a suitable error message or invitation for alternative actions. Preferably, the validation rules determine whether a certain recommended action is reasonable in a given context, e.g. at a given time of day, a given time relative to other events, e.g. relative to meals, relative to previously recommended actions, or the like.

In the context of blood glucose control, examples of such validation rules include rules that prevent certain recommendations, such as “eat a snack” or “do exercise for 20 minutes” to be repeated several times and rules that prevent such recommendations to be given at certain times of the day, e.g. during sleeping hours. For example, a list of validation rules may include one or more of the following examples:

“If it is sleeping hours, do not recommend exercise.”

“If exercise has been done within the last two hours, do not recommend exercise.”

“If insulin injection has been given within the last three hours, do not recommend insulin injection.”

“If a meal has been eaten within the last hour, do not recommend a snack.”

It is understood that in a computer-implemented implementation of such rules, the rules may be formulated in a formalised language.

FIG. 5 shows a block diagram of an embodiment of the supervisor module 103 shown in FIG. 2. The supervisor module 103 receives the model outputs 107a, 107b, . . . , 107n from a number of different advisory modules. The model outputs are fed into a combiner module that determines a recommended action from the received model outputs. For example, in an embodiment where each of the model outputs 107a, 107b, . . . , 107n indicates a recommended action determined by the corresponding advisory module, the combiner module may determine the resulting recommended action as a majority vote of the recommendations of the advisory modules. In another embodiment, where the model outputs represent predictive blood glucose values, the combiner module may determine an average of the individual model outputs representing an improved prediction. From the improved prediction, the combiner module may determine a recommended action adequate for the predicted blood glucose value. The resulting combined recommendation is fed into a selection module 504.

The supervisor module further comprises a reliability module 502. The reliability module receives the model outputs 107a, 107b, . . . , 107n, and determines a measure of reliability from the model outputs. The reliability module 502 compares the reliability measure with a threshold value stored in a data storage 503. If the reliability measure is higher than the threshold value, the reliability module controls the selection module 504 to select the recommended action determined by the combiner module 501 as the resulting output 108. Otherwise, i.e. if the reliability measure is below the threshold, the reliability module controls the selection module 504 to select the fall-back recommended action 109 determined by the fall-back system 104, as described above. Hence, the selection module 504 further receives the output 109 of the fall-back system 104.

For example, in the above-mentioned example where each model output represents a recommended action and where the combiner module determines the resulting recommendation according to a voting scheme, the reliability measure may be determined as the degree of consensus between the individual models, e.g. expressed as the number of votes for the winning recommendation, or the number of the votes for the winning recommendation relative to the next-highest number of votes, or the like. In the above example of the calculation of an average prediction from a number of individual predictions, the reliability measure may e.g. be the variance of the individual predictions.

FIG. 6 shows a block diagram of a medical advisory system. The medical advisory system 600 comprises a central processing unit 601, a memory 602, and a user interface unit 603, both connected to the central processing unit, e.g. via a bus system. The user interface unit allows a user to enter input parameters into the system as well as further inputs such as user-commands invoking and/or controlling the various functions of the advisory system. Accordingly, the user interface comprises a user-input unit such as a keypad, a keyboard, a number of push buttons, a pointing device, a touch screen, or the like. The user interface is further controlled to present the recommended action and, optionally, additional information to the user. Hence, the user interface comprises an output unit, e.g. a display, an audio output device, or the like.

The central processing unit 601 controls the operation of the advisory system and, in particular, implements the advisory modules, the supervisor module, and the fall-back system described above and below.

The memory 602 is adapted to store the computer program(s) implementing the advisory modules, the supervisor module, and the fall-back system described above and in the following, as well as any parameters or other data used by these programs, e.g. model parameters of the advisory models, threshold parameters for the supervisor module, rule tables for the fall-back system, and/or the like. The memory is further adapted to store the input parameters, e.g. as a log file for subsequent analysis or to be used by an adaptive model. It is understood that the memory block 602 may comprise one or more different memory devices, storage media, or memory sections, e.g. a RAM, a ROM, an EPROM, a removable storage medium, and/or the like.

Optionally, the advisory system may comprise one or more further interface units 604 for receiving information, e.g. sensor data from external sensors, and/or for sending/receiving information e.g. to/from a remote computer. Examples of data provided by the advisory system to a central computer or database server for further processing may include information about the input parameters, the recommended actions, log data, and/or the like.

It is understood that the advisory system may be implemented as a single device, e.g. a suitably programmed personal computer. When the advisory system is implemented as a hand-held device or a device worn by the user, e.g. as a suitably programmed hand-held computer, a PDA, a mobile telephone, a watch-like device, or the like, the advisory system may easily be carried around by the user and is thus available irrespective of the user's location etc.

In other embodiments, the advisory system may be implemented as a distributed system, e.g. a client/server system. An example of a client server system is described in connection with FIG. 7.

FIG. 7 shows a block diagram of a medical advisory system comprising a hand-held electronic device and a remote data processing system. The system comprises a hand-held device 700 and a server computer 705. The hand-held device, e.g. a mobile telephone, a PDA, or the like, provides a display 701 and a keypad 702, or another suitable user-interface for receiving input parameters and for presenting the recommended action to the user. The hand-held device sends the received input parameters via a communications network 704 to the server computer 705. For example, in an embodiment where the hand-held device is a mobile telephone, the communications network may be a cellular telecommunications network. The data may be communicated between the hand-held device and the server computer via a short message service, via a suitable network protocol, or the like. The server computer 705 comprises a suitable communications interface 706 for receiving data from the hand-held device and for sending data to the hand-held device. The server computer 705 further comprises the processing unit 601 and the memory or other storage means 602 as described above.

Hence, the advisory system may be incorporated in a telemedicine system, where a central computer provides a number of services to a user, and even allows supervision by or communication with a physician or other health personnel.

With reference to FIGS. 8-11, examples of advisory models will be described in greater detail.

FIG. 8 illustrates an advisory module based on look-up tables. The advisory module generally designated 102 receives one or more input parameters 106 and generates a model output 107 as described above. The advisory module comprises an input coding block 801 that generates a bit pattern 802 representing the input parameter(s). Based on the bit pattern 802, a number of address decoders 803 identify respective columns of a number of look-up tables 806. Hence, each look-up table is connected to the input via an address decoder. Each address decoder 803 is connected to at least a subset of the bits of the bit pattern 802, e.g. between 5 and 20 bits. However, other embodiments may use a different number of bits. The bits connected to each address decoder may be chosen randomly or by some training algorithm. The information from the columns identified by the address decoders is fed into an output block 809 that generates the model output 107. Hence, the advisory model generates a model output y=M(x, p) as a function M of the input parameters x and the entries p of the look-up tables.

The bit pattern 802 comprises a bit string representing the input values as exemplified by the bits labelled b1, b, b3, b4, . . . , bn, i.e. a string of ones and zeroes. As an example, the address decoder labelled AC1 in FIG. 8 is connected to the bits b1, b2, and b4. Each input variable is represented in a certain part of the bit pattern. For example, each input parameter may be encoded by a predetermined number of bits, e.g. 16, 32, or 64 bits. However, it is understood that in principle any bit resolution may be chosen for an input parameter. It is further understood that different input parameters may be encoded with the same or different bit resolutions.

FIGS. 9a-c illustrate examples of an input layer coding in the advisory system of FIG. 8. The input parameters may be encoded into a bit representation in many ways. For numerical parameters, e.g. a hart rate, blood glucose level, an insulin dosage, or the like, FIGS. 9a-b illustrate examples of suitable coding schemes. The coding scheme of FIG. 9a is referred to as “thermometer coding”, since the number of consecutive bits that are set to “1” correspond to the value of the input parameters. This is exemplified in FIG. 9a by a bit string 802 where the fraction 901 of bits is set to “1” while the fraction 902 is set to “0”. The encoding of FIG. 9b is referred to as “neighbour coding” where a predetermined number of consecutive bits is set to “1” (as illustrated by the shaded area 901) while the remaining bits are set to “0” as illustrated by the white areas 902. The number of bits that are set to “1” is the same for all input values, but the position of the bits that are set to “1” in the bit string depends on the value of the input parameter, i.e. the bit pattern resembles a slider, the position of which indicates the value of the input parameter. FIG. 9c illustrates an example of the input coding of symbolic input values, e.g. the identification of the type insulin administered, the type of food consumed, or the like. In this example different parts of the bit string are assigned to each symbol or category, and the actual symbol or category entered is represented by setting the bits in a corresponding one of the parts to “1” and by setting the bits in the remaining parts to “0”, as exemplified by the parts designated 901 and 902, respectively, of the bit string 802 in FIG. 9c.

FIG. 10 illustrates one of the look-up tables of the model of FIG. 8. The look-up table 806 is a matrix including rows 1002 and columns 1003. During operation, a column is selected by the address decoder 803 based on the values of the input bit pattern, as exemplified by column 1004 in FIG. 10. The contents of the cells of the selected row are fed into the output block 809. There is one row for each possible recommended action and one column for each possible address that can be generated by the address decoder 803.

The address decoder 803 determines the address of one of the columns 1004 from the bit pattern, e.g. directly, by a hash coding scheme, or by any other suitable method. Hence, each look-up table may be considered as being indexed by a subset of the input bits. For example, when each bit pattern directly encodes one of the columns, and when n connections from the input bit pattern to the address decoder 803 are used, then the number of addressable columns in the corresponding look-up table is 2ⁿ. As the number of columns grows exponentially with the number of connections, it is preferred to use a compression technique or sparse coding technique for the look-up table, thereby allowing an efficient addressing even for many connections.

In one embodiment, the number of connections between the input bit pattern and the address decoder is the same for all look-up tables in the advisory module. Hence, the length of the input bit string divided by the number of connections from the input bit string to each of the address decoders determines the minimum number of look-up tables needed to make connections to all of the bits in the input string. In an embodiment, where the connections are selected randomly the actual number of look-up tables used may be considerably larger, e.g. twice or three-times as high, as that minimum number.

The output block 809 comprises a number of summation units 1001, each summation unit corresponding to a row of the look-up table, i.e. to one the possible recommended actions.

As mentioned above, the mapping from the input parameters to the determined recommended action is determined by the content of the cells of the look-up tables. Hence, by determining the contents of the cells, the advisory system may be adapted to a specific patient, e.g. by an adaptation or “training” algorithm based on a set of training examples, each example comprising a set of input parameter values and the desired output, i.e. an indication of the desired recommended action for this set of input parameter values.

In one embodiment, the advisory system based on look-up tables is trained according to the following procedure:

Initially, all the cells in each of the look-up tables are set to zero. During the training process, some of the cells are marked or assigned a number, normally a positive integer.

In particular, in one embodiment, the following steps are performed for each of the training examples:
1. The input parameter values are pre-processed resulting in a corresponding input bit string, and the bit string is fed into each of the address decoders.
2. Each address decoder determines a corresponding column of the look-up table connected to that address decoder, based on the set of bits of the input bit string that are connected to that address decoder.
3. For each look-up table, the row that corresponds to the target recommended action for the present training example is selected.
4. The value in the cell that corresponds to the selected row and the selected column is incremented by one. In one embodiment, each cell corresponds to a binary value. In this case the value of the cell is incremented only the first time the cell is selected, corresponding to setting a flag, thereby providing a compact and efficient coding.

It is noted that the training procedure described above is a “one pass” training process, thereby providing a fast training or adaptation. It is a further advantage that an initial training based on a set of training examples may subsequently be supplemented by additional examples. Hence, an incremental training, or even an “untraining” of selected examples, is possible.

Once trained, i.e. once the values of the cells of the look-up tables are determined, e.g. according to the above procedure, the advisory module performs the following process during operation:
1. A set of input parameter values is fed into the input coding block 801.
2. The input coding block pre-processes the input parameter values and generates an input bit string 802.
3. For each look-up table 806, a corresponding sub-set of input bits is fed into the corresponding address decoder 803.
4. Each address decoder calculates a column number based on the bits represented at its connections with the input bit string, and selects that column in the corresponding loo-up table 806.
5. For each look-up table, each cell in the corresponding selected column that has a value greater than zero increments the corresponding one of the summation units 1001 of the output block 809.

Consequently, in one embodiment, after all look-up tables have been processed, the accumulated value in each summation unit corresponds to a number of votes for the corresponding recommended action. The largest possible number of votes is the number of look-up tables in the advisory module, and the smallest number is zero. The recommended action with the most votes is represented as the output by the system, corresponding to a so-called “winner-takes-all” procedure. If more than one recommended actions have received the same number of votes, i.e. the same value of the corresponding summation unit, they are all represented as outputs.

Hence, in the above, an advisory model based on look-up tables has been disclosed. For a more detailed description of a classification system based on adaptive look-up tables, reference is made to WO 99/67694 which is incorporated herein in its entirety by reference.

In some embodiments, the output block 809 directly determines one or more reliability measures based on the contents of the summation units.

In the following, two examples of reliability measures that can immediately be calculated by the output block 809 will be described: A confidence measure and an ambiguity measure.

A confidence measure may be considered as answering the question: “How much do we believe in the result?” In one embodiment, the output block 809 calculates a confidence measure from the value of the summation unit of the “winner”, i.e. the summation unit having the largest value, relative to the largest possible value, i.e. the number of look-up tables, i.e. according to
L_{confidence}=S₁/N_{LUT}

Here, S₁ is the largest summation value, and N_{LUT} is the total number of look-up tables. An example of such a confidence level is illustrated in table 1 below.

TABLE 1
Example of a confidence level

| Largest summation | |
|---|---|
| value in pct of max. | |
| obtainable value | Expected success rate |
| 100% | Very sure; matching the training examples. |
| | 100% correct. |
| 70%-99% | Sure; >95% correct. |
| 50%-69% | Probable; 85%-94% correct. |
| Less than 50% | Dubious; less than 84% correct. |

An ambiguity measure may be considered as answering the question: “Is the winner really the correct winner?” In one embodiment, the output block 809 calculates an ambiguity measure from the value of the summation unit of the “winner”, i.e. the summation unit having the largest value, relative to the value of the summation unit having the second-largest value. For example, the ambiguity value L_{ambiguity} may be expressed as
L_{ambiguity}=(S₁−S₂)/N_{LUT},

where S₁ is the largest summation value, S₂ is the second-largest value, and N_{LUT} is the total number of look-up tables. An example of such an ambiguity level is illustrated in table 2 below.

TABLE 2
Example of an ambiguity level

| Ambiguity level in pct | |
|---|---|
| of max votes. | Expected success rate |
| More than 10% | 99%, Very sure selection of winner |
| 10% to 5% | 95%, Sure |
| 5% to 3% | 90%, Probable |
| Less than 3% | Less than 90%, Dubious |

In the above tables, the confidence and ambiguity levels are related to expected success rates, i.e. to the percentage of correctly determined recommended actions for results having the corresponding confidence/ambiguity level. It is understood that the above tables are merely intended as illustrative examples. For a specific system, reference ambiguity levels may be determined by the following method:
1. A one-pass training of the look-up table advisory module is performed as described above.
2. A full leave-one-out cross-validation on all the training examples is performed by unlearning, testing and relearning the examples one by one. Hence, during each iteration of the cross-validation procedure, the advisory system is trained with all but one examples and tested on the example that was left out during training.
3. Based on the votes given to the tested examples, precise confidence and ambiguity levels can be calculated, e.g. by sorting the training examples in bins of vote intervals, and by calculating the error rate for each bin.

It is understood that a finer selection of confidence and ambiguity levels than shown in the tables can be calculated by the above procedure.

It is further understood that alternative reliability measures may be employed. For example, a reliability measure combining the two above measures can be calculated in different ways, dependent on the cost of different types of errors. In one embodiment, the reliability measure may be determined according to the following equation:
Reliability(y)=(L_{confidence}(x)*L_{ambiguity}(x))/Cost_factor(y),
where x is an input example and y is the classification made by the trained advisory system. The Cost_factor is a table or function that assigns a cost factor to each recommended action y.

FIG. 11 illustrates a diabetes advisory model for controlling the blood glucose value of a user, where the recommended action is determined on the basis of a prediction of the user's future blood glucose value. The advisory module generally designated 102 receives one or more input parameters 106 and generates a model output 107 as described above. The advisory module comprises a prediction module 1101, a control module 1102, a data storage 1103, and an output module 1104. The prediction module receives the input parameters, e.g. the blood glucose value at time to and information about actual and/or anticipated intake of food and/or insulin and/or actual/anticipated physical exercise within a predetermined period of time around t₀. From the input parameters, the prediction module calculates a predicted blood glucose value for a predetermined later time t₁. The prediction module may implement any suitable known prediction algorithm. Examples of such algorithms include an adaptive algorithm as described in V. Tresp et al., “Neural Network Modelling of Physiological Processes”, in Hanson S. J. et al. (Eds.), Computational Learning Theory and Natural Learning Systems 2, MIT Press, 1994, the algorithm described in U.S. Pat. No. 5,822,715, or the like. The predicted blood glucose value is fed into the control module 1102 which determines a recommended action based on the predicted blood glucose value and a predetermined control strategy stored in data storage 1103. The determined recommended action is fed into the output module 1104 which generates the model output. Examples of control strategies for blood glucose control are disclosed in R. Bellazzi et al., “Adaptive controllers for intelligent monitoring”, artificial Intelligence in Medicine 7 (1995) 515-540, and in U.S. Pat. No. 5,822,715. In some embodiments, the prediction module further determines a reliability measure 1105 and feeds the reliability measure into the output module 1104 which may incorporate the reliability measure in the model output 107. For example, the prediction module may implement a plurality of different prediction algorithms. The predicted blood glucose value of such an ensemble may be determined as the average of the individual predictions and the reliability measure may be determined as the variance of the individual predictions.

It is further understood that the prediction module and/or the control module may be adaptive. An example of an adaptive control strategy is disclosed in R. Bellazzi et al. (ibid.)

Other examples of advisory models are based on a physiological model of the physiological process in question. Examples of physiological models in the context of diabetes management include the models described in U.S. Pat. No. 5,822,715 and in “A physiological model of glucose-insulin interaction in type 1 diabetes mellitus”, by E. D. Lehmann and T. Deutsch, J. Biomed. Eng. 1992, Vol. 14, May, pages 235-243.

In the following, another example of a reliability measure for an advisory system will be described. According to this example, the reliability measure is based on a sensitivity analysis, i.e. an analysis of how sensitive the system is to small changes in the input variables. A sensitivity analysis may be regarded as a “what if” type of analysis where all the input variables are systematically changed the by a small step in “all directions” compared to the actual input, and the change in output (if any) is observed.

In one embodiment, a gradient map of the output of the advisory model or the output of the prediction module is determined at a given input point x. Such a gradient map may for example be calculated by presenting a series of input parameters xₖ to the advisory system, the series being generated by incrementing/decrementing one or more of the input parameters by predetermined steps according to xₖ=x+Δxₖ. The gradient map can thus be estimated from the corresponding series of output values yₖ=M(x+Δxₖ, p). The gradient map is used to make an assessment of the systems reliability and/or brittleness in the given input point.

In order to determine reliability from a gradient map, all output changes in the gradient map are classified as “harmfull” or “not harmfull” with respect to the probability of increasing the risk of e.g. hypoglycaemia based on a medical assessment. This may be combined with an assessment of the certainty or sureness of the input value, where a small step change has produced the output change. For example, in the context of diabetes, the assessment of precision of input parameters may be done on the basis of experience from clinical measurements involving many persons with diabetes. The following table illustrates an example of the determination of the system reliability for each gradient in the map.

TABLE 3
Example of the assessment of sensitivity of an advisory system.

| Input variable reliability | Change quality | System reliability |
|---|---|---|
| Reliable | not harmful | Reliable |
| Reliable | harmful | Reliable |
| not reliable | not harmful | Reliable |
| Not reliable | harmful | Not reliable |

If one or more of the input variables produce a “system not reliable” assessment based on the sensitivity analyses, the system as such is not reliable in that working point.

The assessment table can be refined using more than two different values (ie “reliable”, “somewhat reliable” and “not reliable”) for the column parameters, thereby yielding a fuzzy assessment.

In the following, an example of a rule-based fall-back system will be described. According to this example, the rule-based fall-back system comprises an exhaustive set of state description points, e.g. defined by a set of conditions. Each point is associated with at least one valid recommendation.

The conditions for the state description points may comprise simple conditions and be related to a single recommendation, e.g. “if condition A then action B”. However, alternatively or additionally, the system may comprise more complex rules comprising more than one condition and/or being associated to more than one recommendation. An example of such a complex rule may have the following structure: “If condition A and condition b and condition c and . . . , then action x or action z”. It is understood that an increasing complexity of rules may give rise to a combinatorial explosion of the number of rules.

In one embodiment, complex set of rules are processed by defining a set of state descriptor variables. In one embodiment, the set of state descriptor variables is selected as a subset of all the parameters available to the system. Preferably, the set of state descriptor variables is selected such that the amount of information provided by the selected set is high and, at the same time, redundant information and noise is eliminated. For example this may be achieved by an incremental selection process during the design of a rule-based fall-back system. In a first step, a subset of state descriptor variables is selected that have a high correlation with the intended parameter to be controlled. Starting from this subset, additional state descriptors may be added, and the performance of the resulting system may be tested and compared with the system without the additional state descriptors. This may e.g. be done by a cross-validation procedure. If the system with the added descriptor variables performs better than the system without the added variables, the incremental process may be continued by adding one or more further variables. If the addition of further variables does not yield an improvement in performance, the process is stopped, and the previous subset is selected as the final set of descriptor variables.

Preferably, each descriptor variable is defined such that its range is exhaustive, i.e. it covers the entire range of possible values, and mutually exclusive. Here the term “mutually exclusive value” is intended to mean that, if a given value is assigned to a variable, no other values are possible at the same time. For example, if a state descriptor variable can take the values “low”, “medium”, and “high”, where each of the above values corresponds to an interval of measured values of a physiological parameter, these intervals should combine to the entire range of the physiological parameter, and the intervals should not overlap with each other.

An example of a rule for a diabetes type 1 patient could be: “If blood glucose (BG) is higher than 9, and a meal is coming up within an hour, and no exercise is planned, then increase next pre-prandial insulin injection with one unit”. This rule can be put into a table form as follows:

| Result | BG measure | Exercise near | Insulin near | Food near |
|---|---|---|---|---|
| Increase | High | no | yes | yes |
| Insulin | | | | |

Here, the BG measure is classified as “low”, “OK”, or “high”. Hence, in this simple case, the description consists of four variables, which can take on three (“High”, “OK”, “Low”) or two (“yes”, “no”) values.

Table 4 below illustrates an example of a set of rules and their corresponding conditions in a fall-back system:

TABLE 4
Example of a set of rules of fall-back system.

| Action | BG measure | Exc near | Insulin near | Food near |
|---|---|---|---|---|
| Do nothing | OK | * | * | * |
| Insert insulin | Too high | yes | no | no |
| Insert excersize | Too high | no | no | no |
| Increase food | Too low | yes | yes | yes |
| decrease Insulin | Too low | no | yes | yes |
| Increase food | Too low | no | yes | yes |
| Add food | Too low | no | no | no |
| Increase Insulin | Too high | no | yes | yes |
| Insert insulin | Too high | no | no | yes |
| Increase exercise | Too high | yes | no | yes |
| decrease Insulin | Too high | no | yes | no |
| Insert exercise | Too high | no | yes | no |
| Increase Insulin | Too high | yes | yes | no |
| Decrease food | Too high | yes | yes | yes |
| Increase food | Too low | no | no | yes |
| Increase food | Too low | yes | no | yes |
| Increase Insulin | Too high | yes | yes | no |
| Add food | Too low | yes | no | no |
| decrease Insulin | Too low | yes | yes | no |
| Add food | Too low | yes | yes | no |
| Add food | Too low | yes | yes | no |
| decrease exercise | Too low | yes | no | yes |
| Insert exercise | Too high | no | no | yes |

In particular, table 4 is intended as an illustrative example of a set of rules that qualitatively tells what a type 1 diabetes patient should do in order to correct an out-of-normal range BG measurement. It is understood that, in a practical implementation, the ranges labelled “too high”, “OK”, “too low” may be replaced by actual blood glucose intervals. Similarly, an exercise, a meal, or insulin injection being “near” is preferably determined more precisely, e.g. within the next 15 or 30 minutes, the next hour, or the like. Furthermore, the actions may be defined more precisely, e.g. the terms “increase” and “decrease” may be qualified.

There are 24 different combinations of input variable values in this system (3*2*2*2=24). Hence, the total description space consists of 24 four-dimensional points. It is possible to assign an input variable the symbolic value “*”, as e.g. in the first row of table 4. This is a wildcard or “don't care” value, and it means that, independently of what value is assigned to that variable in an input, the result remains the same. Hence, an example containing one or more “don't care” values can be expanded to all the possible input values contained in it. In the above example, the first rule implies that, if the BG value is “OK”, the “do nothing” action is recommended irrespective of the other variables.

It is understood that the set of rules may include additional and/or alternative rules including alternative or additional actions. For example, in some embodiments, special actions may be used. In some embodiments, the set of rules may include a symbolic action labelled “N/A”. This label is used to describe combinations of input values that are forbidden, do not exist, or do not make sense.

The above example of a rule-based fall-back system provides a number of advantages, including:
Clear design requirements and good design overview.
Easy implementation of rules or “wisdom” formulated in natural language.
It is possible to ensure that all possible description states are validated.
It is possible to ensure an exhaustive search for matches in the existing example base when a new example is given.
It is possible to make a list of all examples that have not been assigned a result value yet.
There exists a strategy for constructing a necessary and sufficient input space using this framework.
It is simple to execute the rule-based fall-back system on different platforms.
It is possible to assign a reliability measure to every example in the example base.

In a preferred embodiment, the size of the input space of a rule-based fall-back system is selected sufficiently small to allow the validation of every rule in the rule base. For example, in one embodiment, the input space includes less than 500-1000 combinations. However, it is noted that in embodiments having larger input spaces, the input space may be divided up in smaller modules, e.g. by using known techniques for optimal feature extraction.

During operation, the rule-based fall-back system searches for a match between the input pattern and one ore more of the rules and examples in the rule base. If the rule base is exhaustive, at least one match will be found. The result value(s) of the matching example(s) are presented as valid results. In embodiments where the rule base is not exhaustive, a nearest neighbour search can be used if no match is found.

Another example of a rule-based fall-back system includes a set of rules that depends on a single input variable, e.g. a measured blood glucose level (BG). For example, the rule set may be expressed as follows:

IF (BG<3.5) THEN

(recommended action=“eat something and contact a doctor”);

ELSE IF ((BG≧3.5) AND (BG<8)) THEN

(recommended action=“no action required”);

ELSE

recommended action=“take x units insulin” where x=(BG−5)/3.

Yet another example of a fall-back system may be based on an accepted set of guidelines for clinical practice. Examples of such guidelines include the “A Guide to Type 1 (Insulin-dependent) Diabetes Mellitus”, European Diabetes Policy Group, International Diabetes Federation, European Region, the “ISDAP Consensus guidelines for the Management of Type 1 Diabetes Mellitus in Children and Adolescents”, International Society for Pediatric and adolescent Diabetes, the “Practical Guide for Management of Type 2 Diabetes in Primary Care”, based on the “Approved Guidelines for Type 2 Diabetes of the St Vincent Declaration Primary Care Diabetes Group”, and the “ADA Clinical Practice Recommendations”.

1. A medical advisory system for providing recommendations to a user for actions to be taken, the system comprising:
input means for receiving a number of input parameters;
processing means configured to determine from at least the input parameters a recommended action to be taken; and
output means for presenting information about the determined recommended action to a user;
wherein the processing means is configured to implement a plurality of mathematical advisory models each adapted to generate a respective model output from the received input parameters; and wherein the processing means is configured to determine the recommended action from the model output of one or more of the plurality of mathematical advisory models.

2. A medical advisory system according to claim 1, wherein the plurality of mathematical advisory models comprises at least a first advisory model and a fall-back model; wherein the processing means is configured to select one of the first advisory model and the fall-back model based upon at least one of an input to and a model output of at least the first advisory model; and wherein the processing means is further configured to determine the recommended action from the selected model.

3. A medical advisory system according to claim 2, wherein the processing means is configured to determine a reliability measure for the model output of at least the first advisory model; and wherein the processing means is further configured to determine the recommended action from at least the first advisory model, if the determined reliability measure is above a predetermined threshold, and to determine the recommended action from said fall-back model, if the determined reliability measure is below the predetermined threshold.

4. A medical advisory system according to claim 2, wherein the fall-back model comprises a rule-based fall-back model.

5. A medical advisory system according to claim 3, wherein the rule-based fall-back model comprises an exhaustive list of ranges of input parameters and one or more respective recommended fall-back actions for each of the ranges of input parameters.

6. A medical advisory system according to claim 1, wherein the processing means is adapted to determine the reliability measure from a comparison of at least a first model output of the first advisory model with at least a second model output of a second one of the plurality of mathematical advisory models.

7. A medical advisory system according to claim 1, wherein the processing means is adapted to determine respective model outputs of each of at least a subset of the advisory models, the subset comprising a plurality of mutually different models, and to determine the recommended action from a combination of the determined model outputs.

8. A medical advisory system according to claim 1, wherein at least one of the plurality of mathematical advisory models is an adaptive mathematical model.

9. A medical advisory system according to claim 1, wherein at least one of the plurality of mathematical advisory models comprises a plurality of look-up tables, a corresponding plurality of address decoder modules, and a combiner module; wherein each look-up table includes a corresponding plurality of columns, each column comprising a plurality of table entries; wherein each of the address decoders is adapted to determine one of the plurality of columns of a corresponding one of the look-up tables; and wherein the combiner module is adapted to determine the model output of the mathematical advisory model from the table entries of the determined columns.

10. A medical advisory system according to claim 1, wherein at least one of the plurality of mathematical advisory models comprises a prediction module for predicting a future value of a physiological parameter; and a control unit for determining a recommended action from at least the predicted future value of the physiological parameter.

11. A medical advisory system according to claim 1, wherein at least the input means and the output means are provided by a hand-held electronic device.

12. A medical advisory system according to claim 11, wherein the hand-held electronic device further comprises the processing means.

13. A medical advisory system according to claim 11, wherein the medical advisory system further comprises a remote data processing system comprising the processing means; and wherein the hand-held electronic device comprises communications means for sending the received input parameters to the remote data processing system and for receiving the information about the recommended action from the remote data processing system.

14. A medical advisory system according to claim 1, wherein the medical advisory system is adapted to determine a recommended action for controlling a blood glucose level of a diabetes patient.

15. A computer-implemented method of providing recommendations to a user for actions to be taken, the method comprising:
receiving a number of input parameters;
determining from at least the input parameters a recommended action to be taken; and
presenting information about the determined recommended action to a user;
wherein determining the recommended action further comprises
providing a plurality of mathematical advisory models;
determining one or more respective model outputs of one or more of the plurality of mathematical advisory models and from the received input parameters; and
determining the recommended action from the determined one or more model outputs.

16. A computer program comprising program code means adapted to execute the steps of the method according to claim 15, when said computer program is run on a data processing system.
